(19) United States
(12) Patent Application Publication
(10) Pub. No.: US 2023/0306088 A1
(43) Pub. Date: Sep. 28, 2023

(54) NON-FUNGIBLE-TOKEN VERIFICATION

(71) Applicant: BECKETT COLLECTIBLES HOLDINGS, LLC, Durham, NC (US)

(72) Inventors: Justin HOLBROOK, Orlando, FL (US); Justin A. RICHMOND, Thurmont, MD (US); Bill SUTHERLAND, Dallas, TX (US); Eric Nordelo GALIANO, Madrid (ES); Yifan WANG, San Jose, CA (US)

(21) Appl. No.: 18/186,082

(22) Filed: Mar. 17, 2023

Related U.S. Application Data
(60) Provisional application No. 63/323,445, filed on Mar. 24, 2022.

(30) Foreign Application Priority Data
Feb. 9, 2023 (ES) P202330097

(51) Int. Cl. G06F 21/10

(52) U.S. Cl. CPC G06F 21/10; G06F 2221/0711

(57) ABSTRACT

The methods and systems described herein comprise a method for verifying an electronic article, comprising: receiving a request for a status verification of an electronic article; retrieving one or more aspects associated with the electronic article from a database comprising a plurality of electronic articles comprising the electronic article; providing the one or more aspects to a smart contract; receiving, from the smart contract, one or more corresponding aspects based on the provided one or more aspects; determining the status verification, wherein the status verification comprises a verified status or an unverified status; and providing the status verification in response to the request.

### CROSS-REFERENCE TO RELATED APPLICATIONS

This application claims the benefit of priority to Spanish Application No. P202330097, filed Feb. 9, 2023, and U.S. Provisional Application No. 63/323,445, filed Mar. 24, 2022, each of which are incorporated herein in their entirety.

### BACKGROUND

Currently, there is no optimal way to verify electronic articles, such as Non-Fungible-Tokens (NFTs), or aspects of those electronic articles to prevent fraud or counterfeiting. Similarly, there is no optimal way to update electronic articles or the aspects of those electronic articles to prevent fraud or counterfeiting.

### SUMMARY

An aspect of the disclosure herein describes methods of verifying an electronic article, comprising: receiving a request for a status verification of an electronic article; retrieving one or more aspects associated with the electronic article from a database comprising a plurality of aspects associated with a plurality of electronic articles; providing the one or more aspects to a network comprising a blockchain; receiving, from the network, one or more corresponding aspects based on the provided one or more aspects; determining the status verification, wherein the status verification comprises a verified status or an unverified status; and providing the status verification in response to the request. In some embodiments, the method further comprises providing the one or more aspects to the network comprises querying a smart contract to compare the one or more aspects to the one or more corresponding aspects. In some embodiments, the method further comprises: receiving a hash associated with the electronic article; and providing the hash to the smart contract. In some embodiments, the method further comprises: generating a hash based on the status verification; and providing the hash to a smart contract on the network. In some embodiments, the smart contract is updated to include the hash. In some embodiments, the status verification comprises the verified status. In some embodiments, the status verification comprises the unverified status. In some embodiments, the method further comprises updating a first status associated with the electronic article from unverified to verified based on the status verification. In some embodiments, the method further comprises updating a first status associated with the electronic article from verified to unverified based on the status verification. In some embodiments, the electronic article is a non-fungible token. In some embodiments, electronic article is associated with an analog, wherein the analog comprises at least one of: a photograph; a collectible item; a sports card; a comic book; a coin; an action figure; a pair of shoes; an autograph; a military vintage item; a car part; a videotape; a stamp; a painting; a drawing; music; a building; or a sculpture. In some embodiments, the photograph, the painting, or the drawing comprises a card associated with a sport. In some embodiments, the one or more aspects comprises at least one of: an ownership of the analog; an ownership of the electronic article; an unverified status of the electronic article; a verified status of the electronic article; a type of the analog; a rating of the electronic article; or a first address of the electronic article. In some embodiments, the database is an electronic database not stored on blockchain. In some embodiments, the ownership of the analog comprises an identifier of ownership. In some embodiments, the ownership of the electronic article comprises an identifier of ownership. In some embodiments, the blockchain is associated with a smart contract configured to perform one or more functions associated with electronic articles.

An aspect of the disclosure herein describes methods of amending a smart contract, comprising: receiving an identifier indicating one or more aspects associated with an electronic article; comparing at least one of the one or more aspects to a first set of aspects stored in a database; querying a smart contract associated with the electronic article based on the comparing the at least one of the one or more aspects to the first set of aspects; comparing at least one of the one or more aspects to a second set of aspects associated with the smart contract; and providing an indication to update the second set of aspects based on the one or more aspects. In some embodiments, updating the second set of aspects comprises providing a hash associated with comparing the at least one of the one or more aspects to the second set of aspects, wherein the smart contract is updated based on the hash.

An aspect of the disclosure herein describes methods of minting a verified electronic article, comprising: storing an analog in a database comprising a plurality of analogs; generating an electronic article based on the analog, wherein the minting occurs upon storing the analog; determining a role of a user associated with the analog; verifying the electronic article based the role of the user; and providing a verified status and the electronic article to the user associated with the analog. In some embodiments, the database is a physical database and at least one of the analogs of the plurality of analogs is physical. In some embodiments, the database is an electronic database and each of the analogs of the plurality of analogs is electronic. In some embodiments, the method further comprises receiving the analog. In some embodiments, the analog is associated with a transaction involving the analog. In some embodiments, the electronic article comprises an indication of the verified status when displayed. In some embodiments, the method further comprises storing a copy of the electronic article in the database. In some embodiments, the electronic article is associated with one or more aspects. In some embodiments, the one or more aspects comprises at least one of: an ownership of the analog; an ownership of the electronic article; an unverified status of the electronic article; a verified status of the electronic article; a type of the analog; a rating of the electronic article; or a first address of the electronic article. In some embodiments, the analog comprises at least one of: a photograph; a collectible item; a sports card; a comic book; a coin; an action figure; a pair of shoes; an autograph; a military vintage item; a car part; a videotape; a stamp; a painting; a drawing; music; a building; or a sculpture.

An aspect of the disclosure herein describes methods of minting a verified electronic article, comprising receiving a request for a status of an electronic article, wherein the electronic article is associated with one or more aspects; retrieving a first aspect of the electronic article from a database comprising aspects for a plurality of electronic articles; querying a smart contract associated with the electronic article based on the first aspect; receiving a second aspect associated with the electronic article from the smart contract; determining if the second aspect matches the first aspect; either: verifying a first status based on the second aspect matching the first aspect; or updating the first aspect to match the second aspect; and providing the first status to the user in response to the request.

Another aspect of the present disclosure provides a Quick Response (QR) Code linked to an electronic article of any of the methods above or elsewhere herein. In some embodiments, the electronic article is displayed on a user interface when the QR code is scanned.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the subject matter described herein are set forth with particularity in the appended claims. A better understanding of the features and advantages of the present subject matter will be obtained by reference to the following detailed description that sets forth illustrative embodiments, in which the principles of the present subject matter are utilized, and the accompanying drawings (also “Figure” and “FIG.” herein), of which:

FIG. 1 depicts an exemplary system for minting and/or verifying an electronic article or an aspect of an electronic article;

FIG. 2 depicts an example process for minting an electronic article;

FIG. 3 depicts an example process for updating an electronic article or an aspect of an electronic article;

FIG. 4 depicts an example process for verifying an electronic article or an aspect of an electronic article;

FIG. 5 depicts an example method for verifying an electronic article;

FIG. 6 depicts a computer system that is programmed or otherwise configured to implement methods provided herein;

FIG. 7 depicts one or more example processing devices in communication with one or more other processing devices;

FIG. 8 depicts one or more example processing devices in communication with a network;

FIG. 9 depicts processes that may be performed when a user assigned an admin role provides a request associated with an electronic article;

FIG. 10 depicts an example process for minting an electronic article;

FIG. 11 depicts an example process for checking the status of an electronic article;

FIG. 12 depicts an example process for minting an electronic article and verifying the electronic article;

FIG. 13 depicts an example user interface for displaying an electronic article;

FIG. 14 depicts an example process for updating one or more aspects of an electronic article;

FIG. 15 depicts an example process for providing a status verification to a user who requested a status verification;

FIGS. 16A-C depict example processes for assigning a verified status or assigning an unverified status of an electronic article, as well as an example process for updating a smart contract associated with the electronic article;

FIG. 17 depicts an example electronic article with a verified status; and

FIG. 18 depicts an example QR code associated with an electronic article.

### DETAILED DESCRIPTION

The generating and transferring of electronic articles, such as non-fungible tokens (“NFTs”), has increased in recent years. However, despite the property rights that those electronic articles may confer, fakes or counterfeits may still be created, bought, and transferred between users around the world, which both diminishes the value of the real electronic articles as well as infringes on the rights of the owners of those articles. Thus, there is a need to prevent fraud by use of fake electronic articles and encourage the use of authentic electronic articles.

The methods and systems described herein disclose embodiments for generating (also referred to as “minting”), storing (also referred to as “vaulting”), and verifying electronic articles, which allows users to ensure that each electronic article dealt with is authentic. For example, an analog may be received, which allows for minting of the electronic article based on the analog. Those analogs may further be stored by the system along with duplicates of created electronic articles, which ensures that the no additional authentic electronic token can be created. Thus, by minting and/or vaulting the electronic article, the system can both create an authentic electronic article while also ensuring that no other authentic electronic articles are generated. Therefore, if a copy of the electronic article appears, if it was not received from the system or from a user who received the electronic article from the system, the system can determine that the electronic article is possibly fake by verifying an aspect of the electronic article, such as the ownership or address associated with the electronic article.

Verification of electronic articles allows the system to check if the electronic article is real, such as by comparing one or more aspects stored by the system with one or more aspects stored on a network component, such as a blockchain. For example, if a user requests the status of an electronic article, the system may compare one or more stored aspects to one or more aspects associated with the electronic article stored on the blockchain. Thus, if the one or more stored aspects match the one or more aspects on the blockchain, the system can show that the electronic article is verified by the blockchain, and if the one or more stored aspects do not match the one or more aspects on the blockchain, the system can show that the electronic article is not verified.

Each of the minting, vaulting, and verification steps may be used alone or in conjunction to ensure that electronic articles are authentic by keeping track of where the electronic article was created and stored as well as current aspects of the electronic articles that allow the system to verify that the electronic is indeed authentic.

### Example System for Minting, Vaulting, and/or Verifying Electronic Articles

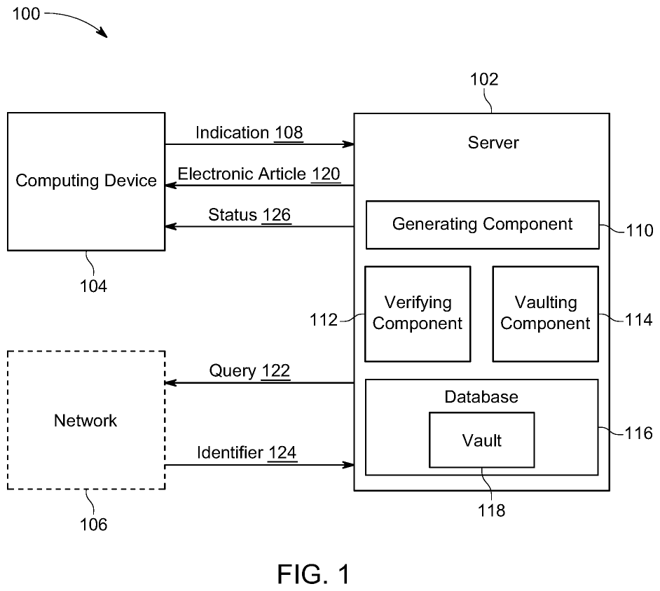

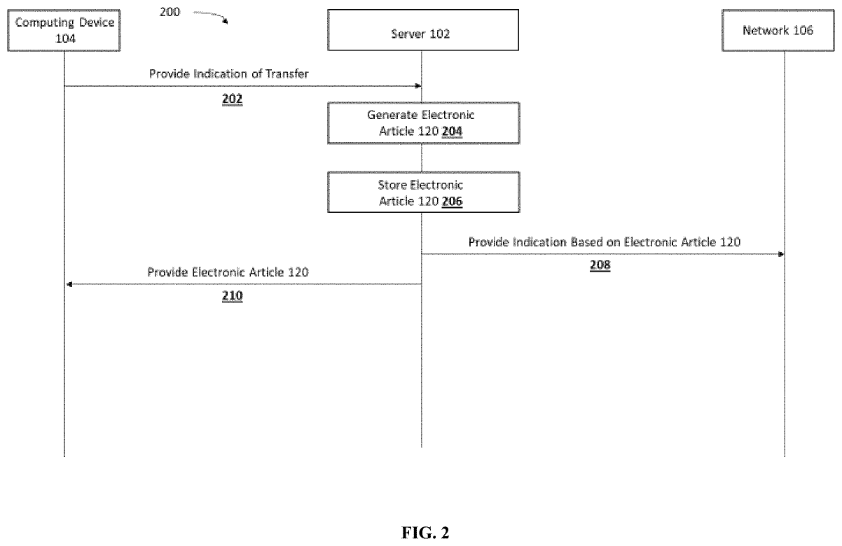

FIG. 1 depicts an example computer system 100 for minting, vaulting, and/or verifying electronic articles. In this depicted example, system 100 comprises a server 102, a computing device 104, and a network 106.

In this depicted embodiment, server 102 further includes generating component 110, verifying component 112, vaulting component 114, and database 116.

Generating component 110 may generate electronic articles, such as NFTs, or copies of electronic articles based on analogs associated with the electronic articles. Analogs may include a physical or electronic object associated with the electronic article, such as a collectible item, a sports card, a comic book, a coin, an action figure, a pair of shoes, an autograph, a military vintage item, a car part, a videotape, a stamp, photograph, a painting, a drawing, music, a building; or a sculpture. In some embodiments, the photograph, painting, or drawing may be a sports card, such as a baseball card. In some embodiments, the analogs may be received by the server 102 from one or more processing devices, such as computing device 104. In some embodiments, indications of a transfer of an analog may be received by the server from one or more processing devices, such as computing device 104. For example, a physical analog may be transferred from one party to another, such as from a first party associated with the computing device 104 to a second party associated with the server 102, and after the transfer, computing device 104 may provide an indication of the transfer. Based on the indication of the transfer, the generating component 110 may then generate an electronic article (e.g., electronic article 120). In some embodiments, the generating component 110 may associate the electronic article with a quick response (QR) code. In those embodiments, the QR code may link the electronic article to its associated analog. When scanned, the QR code may cause a processing device to display the electronic article, the analog, or both.

Vaulting component 114 may receive generated electronic articles and store them or copies of the electronic articles in database 116. In particular, vaulting component may store the copies of electronic articles in vault 118 of database 118. Vaulting component 114 may further record transfers associated with the electronic articles, such as the transfer from a first party associated with computing device 104 to a second party associated with server 102. Vaulting component 114 may also be associated with physical storage for physical analogs, and may record what physical analogs are stored in the physical storage.

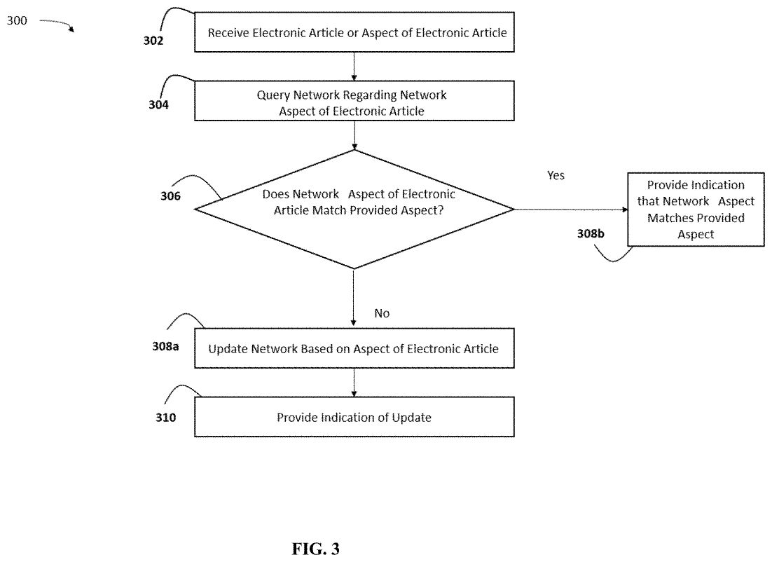

Verifying component 112 may verify an electronic article as authentic or not by assigning a verified status or an unverified status, or may verify one or more aspects associated with an electronic article. In some embodiments, aspects associated with an electronic article may comprise ownership of the electronic article (e.g., an identifier of who owns the electronic article), ownership of the analog (e.g., an identifier of who owns the analog), status type (e.g., verified or unverified), size, analog type (e.g., physical, electronic, virtual, or another type), an address of a user associated with the electronic article, role of a user associated with the electronic article, or an address of a computing device associated with the electronic article. In this depicted embodiment, verifying component 112 verifies electronic articles by comparing one or more aspects associated with the electronic article stored in database 116 to one or more aspects associated with the electronic article stored in network 106 (e.g., on a blockchain within network 106). In some embodiments, verifying component 112 queries network 106 with query 122, and may receive identifier 124 in response to query 122. Querying the network 106 may include calling a smart contract to perform a function, as described below with respect to FIGS. 2-4. In this depicted example, identifier 124 indicates at least one aspect associated with the electronic article (also referred to herein as “corresponding aspects”). After receiving identifier 124, verifying component 112 may compare aspects indicated by identifier 124 to one or more aspects stored in database 116. For example, verifying component 112 may provide query 122 to network 106, which may provide identifier 124 indicating a first address associated with the electronic article. Verifying component 112 may then compare the first address as indicated by identifier 124 to a second address associated with the electronic article in database 116, and if the first and second address match, will assign a “verified” status to the electronic article, while if the first and second address do not match, will assign an “unverified” status to the article. The status 126 may then be stored in database 116. The status 126 may then also be provided to a computing device, such as computing device 104, when the status of the electronic article is requested. While an address is used as an example aspect, this is exemplary, and other aspects may be used.

In some embodiments, verifying component 112 may contain a list of aspects that must be satisfied in order to verify an electronic article or another aspect of an electronic article. In those embodiments, the aspects on the list of aspects may be referred to as “parameters”. In some embodiments, the list of parameters are based on user input. In those embodiments, the list of parameters may be received from computing device 104 or network 106, or may be stored on server 102. In some embodiments, the parameters may be parameters associated with a transaction involving the analog. In some embodiments, if the list of parameters that must be satisfied are not satisfied, the verifying component 102 may label an electronic article or aspect of an electronic article as unverified. In some embodiments, the list of parameters may include a list of approved users, wherein a parameter is satisfied if a user requesting to update an electronic article or verifying the electronic article is in the list of approved users. In some embodiments, the list of parameters may include a list of addresses associated with approved users wherein a parameter is satisfied if a user requesting to update an electronic article or verifying the electronic article has an address in the list of addresses. In those embodiments, if an address associated with an electronic article matches an address in the list of addresses associated with approved users, the verifying component 112 may label the electronic article or aspect of the electronic article as verified (e.g., by assigning a verified status) without satisfying any other parameters. In those embodiments, the verifying component 112 may further query network 106 so that network 106 is updated to reflect that the electronic article or aspect of the electronic article is verified. In those embodiments, a blockchain on network 106 may be updated by adding a hash to the blockchain. The blockchain may be a smart contract. Further, in those embodiments, adding a hash to the blockchain may include adding the hash to a Merkle tree.

Database 116 of server 102 may store electronic articles, including electronic articles generated by generating component 110, and the one or more aspects associated with those electronic articles. For example, database 116 may store status of electronic articles or analogs, ownerships of the electronic articles or analogs, type of the electronic articles or analogs, dates on which the electronic articles or analogs were created, addresses of the electronic articles or analogs, or other aspects of the electronic articles. Database 116 may further include vault 118, which may store copies of electronic articles. In some embodiments, vault 118 only stores electronic articles generated by generating component 110. In other embodiments, vault 118 stores electronic articles not generated by generating component 110 in addition to electronic articles generated by generating component 110. In yet another embodiment, vault 118 only stores electronic articles associated with an analog that has been transferred.

In this depicted example, computing device 104 is in communication with server 102. Computing device may be a processing device such as a laptop, smart phone, server, or other processing device. In this depicted example, the computing device may provide indication 108. Indication 108 may be associated with an electronic article, such as electronic article 120, or an analog of an electronic article. Indication 108 may further indicate one or more aspects of the electronic article or the analog of the electronic article. Indication 108 may also indicate a transfer of the analog or a transaction involving the analog. The one or more aspects may include a status of the electronic article or analog, an ownership of the electronic article or analog, a type of the electronic article or analog, a date on which the electronic article or analog was created, an address of the electronic article or analog, a rating of the electronic article, or another aspect of the electronic article. The status of the electronic article may be a new status indicating that the electronic article has recently been minted, a vaulted status, a verified status, an unverified status, or another status of the electronic article. In some embodiments, the one or more aspects may indicate a transfer associated with the analog. While certain aspects are described above, these aspects are exemplary and other aspects may be used.

In the depicted example, the computing device 104 may further receive the electronic article as well as one or more aspects, such as status 126, from server 102. In some embodiments, computing device 104 may have a user interface component that may be configured to display one or more aspects or the electronic article 120.

Further in this depicted example, network 106 may be configured to receive queries, such as query 122, and may be configured to provide identifiers, such as identifier 124, in response to queries.

Thus, an electronic article, such as electronic article 120, may be generated, vaulted, and verified through system 100. In some embodiments, a transfer of an analog may occur, and the server 102 may generate electronic article 120 based on that transfer using generating component 110. The server 102 may further vault the electronic article in database 116 using vaulting component 114. The server 102 may also verify an aspect, such as status 126, of the electronic article 120, by querying network 106 and comparing an aspect associated with identifier 124 to an aspect stored in database 116. Based on that comparison, the server 102 may mark the status 126 as verified or unverified. In other embodiments, the server 102 may further amend or verify aspects based on one or more aspects indicated by identifier 124. The electronic article 120 and/or the status 126 may then be provided by server 102 to computing device 104.

As described above, the system may be associated with one or more analogs. In some embodiments, each analog of the one or more analogs may be associated with a quick response (QR) code. In those embodiments, the QR code may be displayed on an associated electronic article. When the QR code is scanned, an associated processing device, such as computing device 104, may provide or display an analog or an identifier indicating the analog.

### Example Process of Vaulting an Electronic Article

FIG. 2 depicts an example process for generating and vaulting an electronic article. In this depicted example, the electronic article may be generated by a server, such as server 102. In other embodiments, a different processing device may generate and/or vault the electronic article.

In this depicted example, at step 202, a computing device 104 may provide an indication (e.g., indication 108 of FIG. 1) to server 102. In this depicted example, the indication includes an indication of transfer of an analog. In other embodiments, the indication may indicate a transaction, an aspect associated with an analog, an aspect associated with an electronic article, a change of an aspect associated with an analog, or a change of an aspect associated with an electronic article. In some embodiments, the analog may be physical and stored in physical storage. In some embodiments, the analog may be electronic and may be stored electronically.

In some embodiments, the indication may include one or more associated transaction parameters. In those embodiments, one or more required transaction parameters may need to be satisfied. Further, in some embodiments, a request to verify the electronic article may be received. In those embodiments, the one or more transaction parameters included with the indication must satisfy the one or more required transaction parameters in order for the server to verify the electronic article (e.g., assign the electronic article a “verified” status). For example, one of the one or more required transaction parameters may be an address at which an analog is received. Thus, if the indication of transfer includes the address at which the analog is received, the server 102 will assign the electronic article a “verified” status based on the address included the with the indication matching the required address. As another example, one of the one or more required transaction parameters may be that a user associated with the electronic article is included on a list of “approved users”. Thus, if the indication of transfer indicates that the user associated with the electronic article, and that user is included on the list of approved users, the server 102 will assign the electronic article a “verified status” based on the user being included on the list of approved users.

In this depicted example, the server 102 receives the indication. At step 204, server 102 generates an electronic article (e.g., electronic article 120 of FIG. 1) based on the received indication. In some embodiments, the server 102 may generate the electronic article based on the transferred analog.

The server 102 then stores the electronic article or a copy of the electronic article in a database (e.g., vault 118 of database 116 of FIG. 1) at step 206. In some embodiments, the server 102 does not store the electronic article in a database and instead only the copy is stored. In some embodiments, the server 102 may further store aspects of the electronic article in the database. In some embodiments, the server 102 further generates an indication associated with the electronic article and the transferred analog. In some embodiments, the indication associated with the electronic article and the transferred analog may be considered an aspect of the electronic article. In some embodiments, when receiving a second electronic article after storing the copy of the electronic article, the server 102 may access the database to compare the second electronic article to the copy of electronic article or to compare an aspect of the electronic article to an aspect of the second electronic article.

The server 102 then provides an indication that the electronic article has been generated to network 106 at step 208. Based on the indication provided by server 102, the network 106 may be updated or store a copy of the electronic article. In some embodiments, the server 102 may provide extra indications to the network 106 if an aspect of the electronic article or the analog changes so that network 106 may be updated. In some embodiments, the network 106 may include a blockchain, which may be updated based on the indication. In some embodiments, the blockchain may store the copy of the electronic article.

The server 102 then provides the generated electronic article back to the computing device 104. In some embodiments, the computing device 104 may have a user interface that may display the electronic article.

### Example Process for Updating Aspects of an Electronic Article

FIG. 3 depicts an example process for updating aspects of an electronic article. In some embodiments, the process for verifying an electronic article may include a processing device (e.g., server 102 of FIG. 1) receiving the electronic article, and providing the electronic article or an aspect associated with the electronic article to a network (e.g., network 106 of FIG. 1).

The process begins at step 302 with receiving the electronic article or an indication of the electronic article. The received electronic article or indication may have one or more associated aspects (which may include a subset of aspects called “parameters”), such as a status of the electronic article or analog, an ownership of the electronic article or analog, a type of the electronic article or analog, a date on which the electronic article or analog was created, an address of the electronic article or analog, or another aspect of the electronic article. The status of the electronic article may be a new status indicating that the electronic article has recently been minted, a vaulted status, a verified status, an unverified status, or another status of the electronic article. The received electronic article or indication may further be associated with the network. In some embodiments, the received electronic article or indication and aspects associated with the received electronic article or indication may be stored on a blockchain of the network, with which the received electronic article, the indication, or the received electronic article's associated aspects may be compared with.

In some embodiments, a database associated with the electronic article may store one or more aspects associated with the electronic article. In some embodiments, the one or more aspects associated with the electronic article may be received from the database. The database may further comprise a copy of the electronic article.

In some embodiments, the server 102 may additionally receive a request to mint or generate the electronic article along with the indication. In some embodiments, the request is based on input to a user interface.

At step 304, the network may be queried regarding one or more aspects associated with the electronic article. The network may store one or more corresponding aspects associated with the electronic article separate from the one or more aspects associated with the electronic article in the database. The one or more aspects stored on the network may be received in response to the query.

At step 306, the one or more corresponding aspects associated with the electronic article that were stored on the network are compared to the one or more aspects associated with the received electronic article.

If the one or more aspects associated with the electronic article, such as the associated ownership of the electronic article, match the one or more corresponding aspects on the network, the process proceeds to step 308b, where an indication that the aspects match is provided and that no update is required. In some embodiments, the indication is provided to a computing device (e.g., computing device 104 of FIG. 1).

If the one or more aspects associated with the electronic article do not match the one or more corresponding aspects on the network, the process proceeds to step 308a, where the one or more corresponding aspects on the network are updated to match the one or more aspects associated with the electronic article. In some embodiments, the one or more corresponding aspects on the network are updated only if one or more parameters are satisfied, such as a required aspect associated with the electronic article matching a corresponding aspect on the network. For example, in some embodiments, the network will only update a first corresponding aspect stored on the network (e.g., an address associated with the electronic article) if a required parameter associated with the electronic article (e.g., an ownership of the electronic article determined from the electronic article) matches a parameter on the network (e.g., an ownership of the electronic that is stored on the network). In other embodiments, the one or more corresponding aspects on the network are updated only if a user associated with the electronic article is assigned a specific role. For example, if the user is assigned an “authenticator” role, a first aspect associated with the electronic article may be updated (e.g., a status of the article may be updated from unverified to verified). As another example, if the user is assigned a “revocation” role, the first aspect associated with the electronic article may be updated (e.g., a status of the article may be updated from verified to unverified.)

In some embodiments, updates to the electronic article or aspects of the electronic article may be stored on the network. In those embodiments, the updates may be to a blockchain including one or more blocks that contain or indicate the electronic article or aspects of the electronic article. In some embodiments, the updates may be stored on the blockchain as hashes associated with a smart contract. The hashes may be stored on a smart contract that may execute one or more functions in response to received communications (e.g., a communication indicating a role of a user).

Smart contracts associated with the electronic article may perform one or more functions to update the network when the network is queried. The one or more functions may include an authentication and/or a revocation function, where the smart contract may reference a list of one or more aspects or one or more electronic articles to determine if the received aspect or received electronic article is in the list of one or more aspects or one or more electronic articles, respectively. If the received aspect or received copy of the electronic article is in the list of one or more aspects or one or more electronic articles, the smart contract may execute the authentication function, which may assign a “verified” token to the received aspect or a “verified” status to the received electronic article, and may update the smart contract with a hash indicating the verified token or status. If the received aspect or received copy of the electronic article is not in the list of one or more aspects or one or more electronic articles, the smart contract may execute the revocation function, which may assign an “unverified” token to the received aspect or an “unverified” status to the received electronic article, and may update the smart contract with a hash indicating the verified token or status. Hashes may be stored on a Merkle tree of the smart contract, where each hash may indicate an aspect or an electronic article.

Additionally, in some embodiments, if the received aspect or received copy of the electronic article is not in the list of one or more aspects or one or more electronic articles, the smart contract may execute the “upgrade” function. In some embodiments, the smart contract may execute the upgrade function based on the role assigned to a user associated with the received aspect or electronic article. When executing the upgrade function, the smart contract may add the received aspect or received electronic article as a hash to the Merkle tree.

When or if the one or more aspects are updated, an indication will be provided indicating that the one or more aspects have been updated at step 310. In some embodiments, the indication may be provided to a computing device, such as computing device 104 of FIG. 1. In some embodiments, the computing device may be associated with a user, who may view the indication on a user interface of the computing device. In such a way, the user may provide an electronic article, or aspects associated with an electronic article, in order to update the electronic article or aspects of the electronic article on an associated network.

In some embodiments, the one or more aspects may be updated based on a role. In some embodiments, the role may be assigned to a computing device or a user associated with the computing device. In those embodiments, the role may indicate actions that the processing device may take with regards to updating the one or more aspects.

For example, the computing device or the user associated with the computing device may be associated with an “admin” role. In some embodiments, the admin role indicates that the server may change the aspect (e.g., from verified to unverified, from unverified to verified, or from a first aspect value to a second aspect value) based on the received aspect. For example, if the received aspect is an “unverified” status, and the role associated with the computing device or a user associated with the computing device is an admin role, the processing device may change the status to an unverified status, while if the user associated with the computing device is not an admin role, the processing device may not change the status at all.

Additionally, the admin role may indicate that the processing device may access certain information when vaulting one or more electronic articles or updating aspects. For example, an associated database may contain a list of verified users. If the computing device or the user associated with the computing device is assigned an admin role, the processing device may access the list of one or more verified users. If the electronic article being vaulted is associated with the one or more verified users, the processing device may vault the electronic article and assign the electronic article a verified status upon vaulting based on the user being verified. If the user associated with a request to update one or more aspects of an electronic article is a verified user, the processing device may assign the verified status to the electronic article upon update based on the user being verified.

While the depicted embodiment describes verifying a single electronic article, other embodiments allow for verification of a plurality of electronic articles. For example, the server may provide a verified or unverified status for each electronic article of a plurality of electronic articles using the above method. In another embodiment, the server may provide a single verified status for the plurality of electronic articles (e.g., the plurality itself is assigned a verified or unverified status).

### Example Method for Verifying an Aspect of Electronic Article

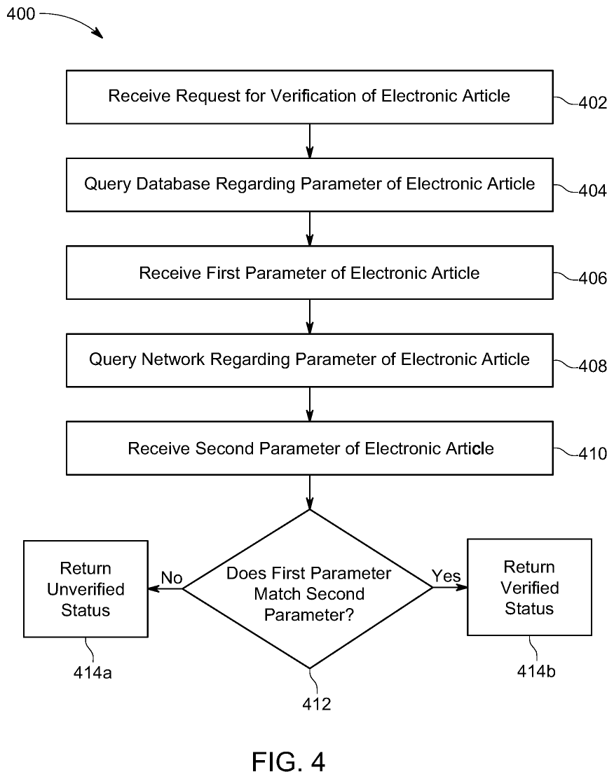

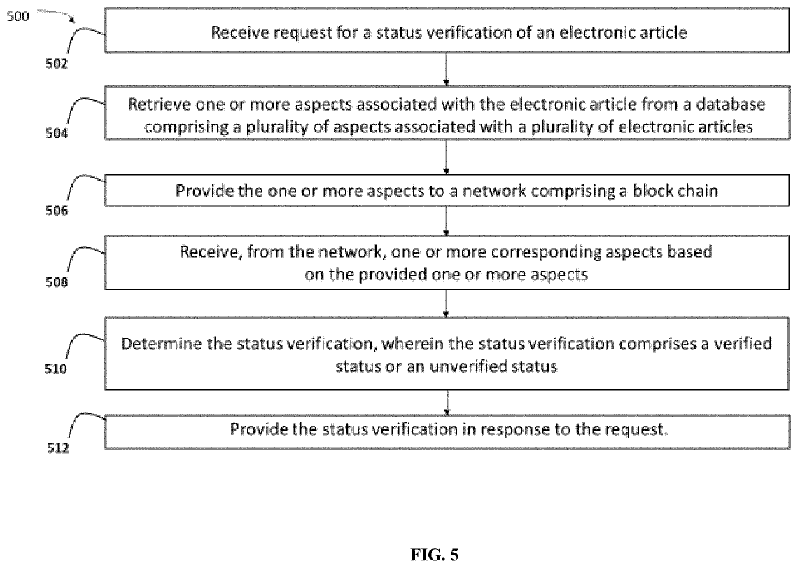

FIG. 4 depicts an example method for verifying an aspect, such as a status, of an electronic article (e.g., electronic article 120 of FIG. 1). In some embodiments, a processing device (e.g., server 102 of FIG. 1) may receive a request and communicate with a network (e.g., network 106 of FIG. 1) and/or another processing device (e.g., computing device 104 of FIG. 1).

In some embodiments, a user associated with an electronic article may wish to verify one or more aspects associated with an electronic article. In this depicted embodiment, the one or more aspects includes a status of the electronic article (e.g., whether the electronic article is verified or unverified). In this depicted embodiment, an unverified status may indicate that the electronic article may be counterfeit.

The method begins with receiving a request for verification of the electronic article at step 402. In some embodiments, a processing device may receive the request. In this depicted embodiment, the request is associated with verifying the electronic article as a whole (e.g., verifying that the electronic article is not counterfeit). In some embodiments, the request may be associated with verifying an aspect or a plurality of aspects of the electronic article. In some embodiments, a different processing device (e.g., computing device 104 of FIG. 1) may provide the request. In some embodiments, the request may be received based on user input to a user interface on the processing device.

At step 404, the processing device may access a database to obtain one or more aspects associated with the electronic article. In some embodiments, the database may be included in the processing device, such as database 106 of FIG. 1 stored on server 102. In some embodiments, the database may not be stored on the processing device.

At step 406, the processing device receives the first aspect. As described above, the first aspect may include a status of the electronic article or analog, an ownership of the electronic article or analog, a type of the electronic article or analog, a date on which the electronic article or analog was created, an address of the electronic article or analog, or another aspect of the electronic article.

At step 408, a network is queried regarding the first aspect of the electronic article in order to determine if the first aspect from the database matches a second aspect stored on the network. In some embodiments, the second aspect may be stored on a blockchain of the network. In some embodiments, the second aspect is stored on a smart contract on a blockchain of the network. In some embodiments, the smart contract may execute one or more functions related to the second aspect, as described above with respect to FIG. 3.

At step 410, the second aspect is received from the network. In some embodiments, the second aspect may be received as a result of an executed function of the smart contract on the network.

At step 412, the processing device determines if the first aspect matches the second aspect in order to determine if the electronic article is verified. In particular, determining if the first aspect and the second aspect match allows the processing device to determine if the information stored in the database is correct or incorrect, if the information stored in the network is correct or incorrect, and/or if certain aspects associated with the electronic article need to be updated. For example, the first aspect may include a first address associated with an owner of the electronic article, and the second aspect may include a second address associated with the electronic article. If the first address matches the second address, the processing device may determine that because its information matches that of the network, it can verify that the electronic article is real (e.g., not counterfeit). However, if the first address matches the second address, the processing device may determine that its information does not match that of the network and thus cannot verify whether the electronic article is real (e.g., not counterfeit).

Depending on the processing device's determination at step 412, the processing device may return a verified status or an unverified status. If the processing device determines that the first aspect and the second aspect do not match, the processing device may return an unverified status at step 414a. If the processing device determines that the first aspect and the second aspect match, the processing device may return a verified status at step 414b. In some embodiments, the processing device may return the verified or unverified status to where it received the request for the status from. In some embodiments, where it received the request from may include the another processing device (e.g., computing device 104).

Thus, by checking both the aspects in the database and the aspects stored on the network, the processing device may determine whether its databases are up to date, and if the information matches, the processing device may verify the information.

In some embodiments, the processing device may alter the electronic article based on the verified aspect or verified status. For example, the processing device may include an identifier on the electronic article indicating the verified aspect or verified status if the processing device verified the electronic article. In some embodiments, the identifier may be present on the electronic article when it is displayed. In other embodiments, the identifier may comprise metadata that may be accessed. In some embodiments, the processing device may alter the electronic article based on the unverified aspect or unverified status. For example, the processing device may include an identifier on the electronic article indicating that the electronic article was not verified by the processing device if the processing device was unable to verify the electronic article. In some embodiments, the identifier may comprise metadata that may be accessed.

As described above, the role of a user associated with the electronic article may allow the server to verify the status of the electronic article upon vaulting. For example, if a computing device associated with one or more users of a list of verified users provides the electronic article for vaulting, the server may immediately provide a verified status for the electronic article without querying the network.

### Example Method for Providing a Status Verification of an Electronic Article

FIG. 5 depicts an example method for verifying an electronic article (e.g., electronic article 120 of FIG. 1). In some embodiments, a processing device (e.g., server 102 of FIGS. 1-2) may provide a status verification classifying the electronic article as verified or unverified.

The method begins at step 502, where a request for a status verification of an electronic article is received. In some embodiments, the processing device receives the request. In some embodiments, a computing device associated with the electronic article (e.g., computing device 104 of FIG. 1) provides the request. In some embodiments, the request is provided based on user input to a user interface of the computing device. In some embodiments, the request may be for a status verification of one or more aspects of the electronic article. As described above with respect to FIGS. 1-4, the one or more aspects may include a status of the electronic article or analog, an ownership of the electronic article or analog, a type of the electronic article or analog, a date on which the electronic article or analog was created, an address of the electronic article or analog, or another aspect of the electronic article. The status of the electronic article may be a new status indicating that the electronic article has recently been minted, a vaulted status, a verified status, an unverified status, or another status of the electronic article. In some embodiments, the one or more aspects may indicate a transfer associated with the analog. While certain aspects are described above, these aspects are exemplary and other aspects may be used.

At step 504, one or more aspects associated with the electronic article are retrieved from a database (e.g., database 116 of FIG. 1) comprising a plurality of aspects associated with a plurality of electronic articles. In some embodiments, the database may comprise a vault (e.g., vault 118 of FIG. 1) that stores copies of electronic articles of the plurality of electronic articles, and the database may further comprise the one or more aspects. If an aspect of an electronic article is updated, the database may also be updated to reflect the change.

At step 506, the one or more aspects are provided to a network. The network may include a blockchain associated with a smart contract. The smart contract may be on a blockchain of a network (e.g., network 106 of FIG. 1). The smart contract may be associated with one or more corresponding aspects of the electronic article. For example, one of the one or more aspects on the database may be a verified status of the electronic article, while the smart contract may be associated with a corresponding status of the electronic article, whether verified or unverified. The one or more aspects retrieved from the database may be compared to the one or more corresponding aspects.

At step 508, the one or more corresponding aspects are received. In some embodiments, the smart contract may perform one or more functions based on receiving the one or more aspects and comparing the one or more aspects to the one or more corresponding aspects, as described above with respect to FIG. 3.

At step 510, a status verification of the electronic article is determined. In some embodiments, the status verification is based on a comparison of the one or more aspects and the one or more corresponding aspects. For example, if one of the one or more aspects matches one of the one or more corresponding aspects, a “verified” status will be provided, whereas if the one of the one or more aspects does not match one of the one or more corresponding aspects, an “unverified” status will be provided. As another example, a first aspect of the one or more aspects from the database may comprise a first blockchain address, while a first corresponding aspect of the one or more corresponding aspects associated with the smart contract may comprise a second blockchain address. If the first blockchain address is the same as the second blockchain address, a verified status will be provided, and if the first blockchain address does not match the second blockchain address, an unverified status will be provided.

At step 512, the status verification is provided. In some embodiments, the status verification is provided to the computing device associated with the electronic article. In those embodiments, the computing device may display the status verification on a user interface for a user to view. The status verification may also be provided to the network. In some embodiments, the smart contract on the network may be updated based on the status verification. In those embodiments, a hash may be added to the blockchain that the smart contract is on, where the hash represents the verification status. In some embodiments, the hash may be part of a Merkle tree.

While various embodiments of the present subject matter have been shown and described herein, it will be obvious to those skilled in the art that such embodiments are provided by way of example only. Numerous variations, changes, and substitutions may occur to those skilled in the art without departing from the subject matter described herein. It should be understood that various alternatives to the embodiments of the subject matter described herein may be employed.

### Computer Systems

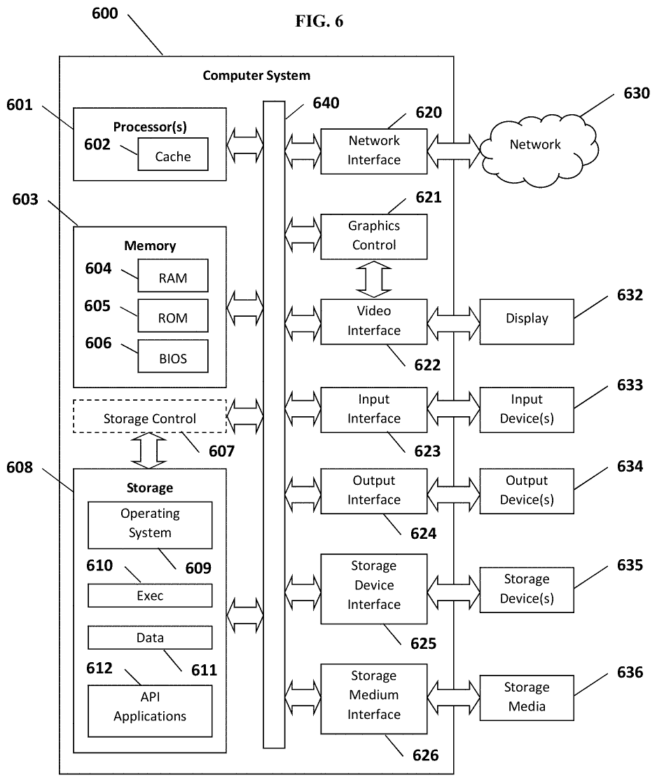

The present disclosure provides computer systems that are programmed to implement methods of the disclosure. FIG. 6 shows a computer system 601 that is programmed or otherwise configured to mint electronic articles or verify electronic articles or aspects of electronic articles. The computer system 601 can regulate various aspects of minting and verification of the present disclosure, such as, for example, receiving electronic articles, indications or identifiers associated with the electronic articles, receiving and comparing aspects associated with electronic articles, or other aspects of the present disclosure. The computer system 601 can be an electronic device of a user or a computer system that is remotely located with respect to the electronic device. The electronic device can be a mobile electronic device.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user (e.g., computing device 104 of FIG. 1). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 601 via the network 630.

Methods as described herein can be implemented by way of machine (e.g., computer processor) executable code stored on an electronic storage location of the computer system 601, such as, for example, on the memory 610 or electronic storage unit 615. The machine executable or machine readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640 for providing, for example, a required list of parameters or a request for a verification of an electronic article or an aspect of an electronic article. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605. The algorithm can, for example, allow the system 601 to mint electronic articles or verify electronic articles or aspects of electronic articles.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

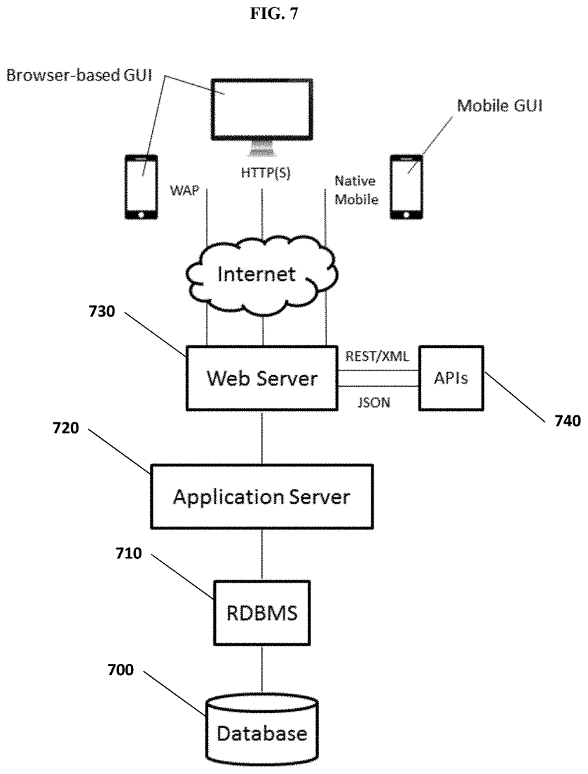

Referring to FIG. 7, in a particular embodiment, an application provision system comprises one or more databases 700 accessed by a relational database management system (RDBMS) 710. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 720 (such as Java servers, .NET servers, PHP servers, and the like) and one or more web servers 730 (such as Apache, IIS, GWS and the like). The web server(s) optionally expose one or more web services via app application programming interfaces (APIs) 740. Via a network, such as the Internet, the system provides browser-based and/or mobile native user interfaces.

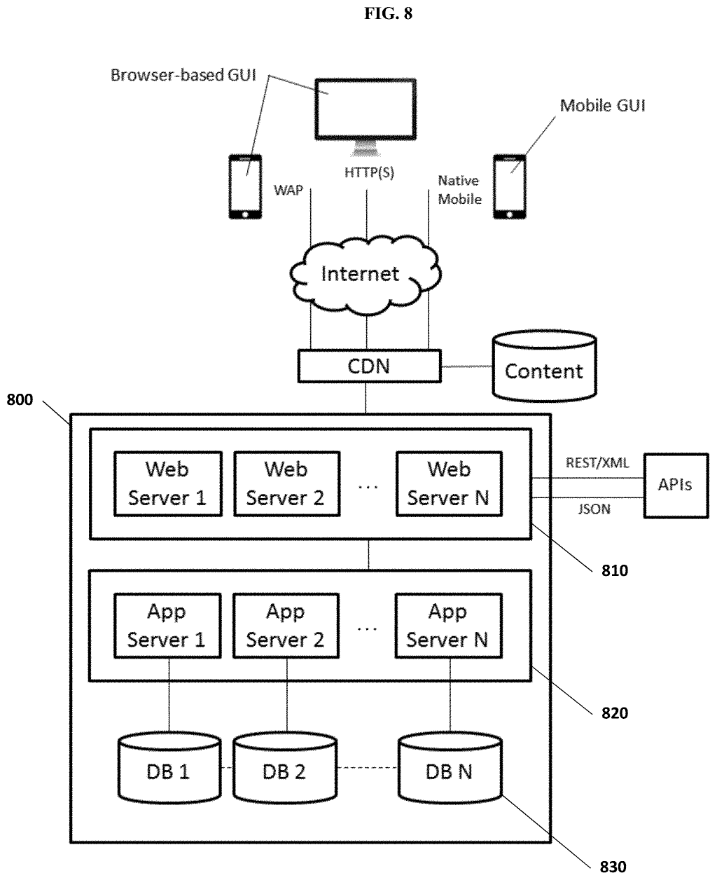

Referring to FIG. 8, in a particular embodiment, an application provision system alternatively has a distributed, cloud-based architecture 800 and comprises elastically load balanced, auto-scaling web server resources 810 and application server resources 820 as well synchronously replicated databases 830.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user information, electronic article information, verification status information, value information, physical article information, and vaulting information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of systems and methods described herein and are not meant to be limiting in any way.

### Example 1: Verifying or Updating by an Administrator

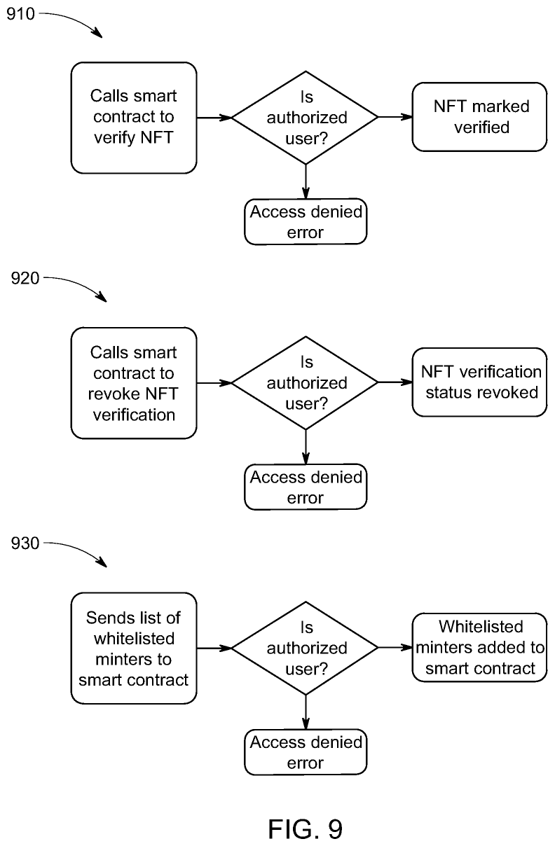

As described above, a user or a computing device associated with a user may be assigned one or more roles, as described above with respect to FIGS. 1-4. A user interacted with a computing device assigned an “admin” role, as depicted in FIG. 9. For example, during process 910, through user input to a user interface of the computing device, the computing device requested to verify the status of NFT that was not yet associated with a status verification. A server associated with the NFT checked a list of authorized users to determine if the user is included in the list of authorized users. After determining the user was included in the list of authorized users (e.g., determining if one or more parameters are satisfied as described above), the server assigned a verified status to the NFT. A network containing a blockchain that includes the NFT was then updated with a hash indicating the verified status.

In an alternative embodiment of process 910, the computing device was not assigned an admin role. Through user input to a user interface of the computing device, the computing device requested to verify the status of NFT that was not yet associated with a status verification. A server associated with the NFT checked a list of authorized users to determine if the user is included in the list of authorized users. After determining the user was not included in the list of authorized users (e.g., determining if one or more parameters are satisfied as described above), the server returned an indication that no change in the verification status was made.

During process 920, the computing device was assigned an admin role. Through user input to a user interface of the computing device, the computing device requested to revoke the verified status of an NFT with a verified status. A server associated with the NFT checked a list of authorized users to determine if the user is included in the list of authorized users. After determining the user was included in the list of authorized users (e.g., determining if one or more parameters are satisfied as described above), the server assigned an unverified status to the NFT to replace the verified status. A network containing a blockchain that includes the NFT was then updated with a hash indicating the unverified status.

In an alternative example of process 920, the computing device was not assigned an admin role. Through user input to a user interface of the computing device, the computing device requested to revoke the verified status of an NFT with a verified status. A server associated with the NFT checked a list of authorized users to determine if the user is included in the list of authorized users. After determining the user was not included in the list of authorized users (e.g., determining if one or more parameters are satisfied as described above), the server assigned an unverified status to the NFT to replace the verified status. After determining the user was not included in the list of authorized users, the server returned an indication that no change in the verification status was made.

During process 930, the computing device was assigned an admin role. Through user input to a user interface of the computing device, the computing device requested to update the list of authorized users on a smart contract to match the list of authorized users stored in a database. A server associated with the NFT checked a list of authorized users to determine if the user is included in the list of authorized users. After determining the user was included in the list of authorized users (e.g., determining if one or more parameters are satisfied as described above), the server generates a hash to update the list of authorized users on the smart contract. A network containing a blockchain that includes the NFT was then updated with the hash indicating the change to the list of authorized users on the smart contract.

In an alternative example of process 930, the computing device was not assigned an admin role. Through user input to a user interface of the computing device, the computing device requested to update the list of authorized users on a smart contract to match the list of authorized users stored in a database. A server associated with the NFT checked a list of authorized users to determine if the user is included in the list of authorized users. After determining the user was not included in the list of authorized users (e.g., determining if one or more parameters are satisfied as described above), the server returned an indication that no change in the list of authorized users was made.

### Example 2: Minting an NFT by an Authorized User

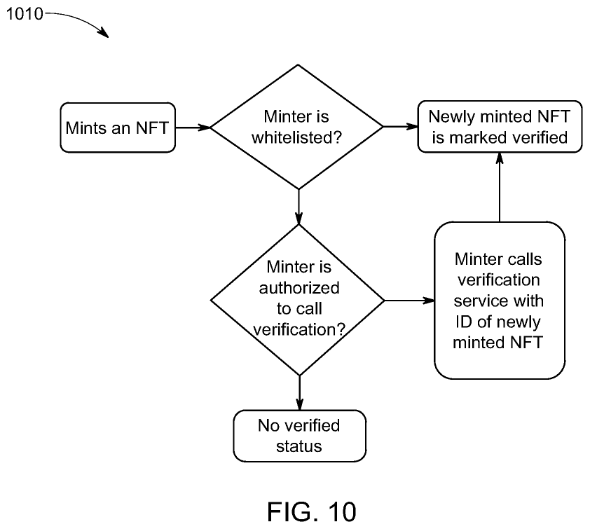

A user interacting with a computing device mints an NFT at the beginning of process 1010 as depicted in FIG. 10. During process 1010, through user input to a user interface of the computing device, the computing device requests to mint an NFT. A server received the request and minted the NFT. The server then determined if the user interacting with the computing device was in a list of authorized users stored on a database associated with the server. After determining the user is in the list of authorized users (e.g., determining if one or more parameters are satisfied as described above), the server calls the verification service and assigns a verified status to the NFT.

In an alternative example also depicted in process 1010, the computing device requests to mint an NFT. A server received the request and minted the NFT. The server then determined if the user interacting with the computing device was in a list of authorized users stored on a database associated with the server. The server then determines if the user is assigned a role such as an admin role that allows the user to verify statuses or revoke statuses of NFTs (e.g., determining if one or more parameters are satisfied as described above). After determining the user is not assigned such a role, the server does not assign a verified status to the NFT. The server then receives user input indicating that the verification service should be called. Upon determining that the user is authorized to verify the NFT, the server assigns a verified status to the NFT.

In another example of process 1010, the computing device requests to mint an NFT. A server received the request and minted the NFT. The server then determined if the user interacting with the computing device was in a list of authorized users stored on a database associated with the server. The server then determines if the user is assigned a role such as an admin role that allows the user to verify statuses or revoke statuses of NFTs (e.g., determining if one or more parameters are satisfied as described above). After determining the user is not assigned such a role, the server provides an indication the status of the NFT is unverified.

### Example 3: Requesting a Verification for an NFT

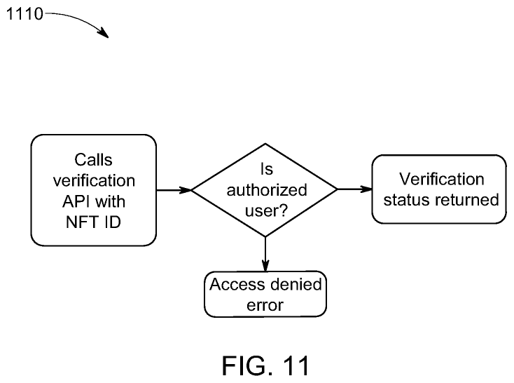

A user interacting with a computing device requests a status verification of an NFT as depicted in FIG. 11. During process 1110, through user input to a user interface of the computing device, the computing device requests a status verification of an NFT by providing the request to a server associated with the NFT. Upon receiving the request, the server determines if the user is in a list of authorized users (e.g., determining if one or more parameters are satisfied as described above). Upon determining that the user is in the list of authorized users, the server retrieves the status verification and returns it to the computing device.

In an alternative example of process 1110, through user input to a user interface of the computing device, the computing device requests a status verification of an NFT by providing the request to a server associated with the NFT. Upon receiving the request, the server accesses a database to retrieve one or more aspects, and queries a network to retrieve one or more corresponding aspects. The server determines if the one or more aspects and the one or more corresponding aspects match. Upon determining the one or more aspects and the one or more corresponding aspects match, the server assigns a verified status to the NFT, and returns an indication of the verified status to the computing device.

In another example of process 1110, through user input to a user interface of the computing device, the computing device requests a status verification of an NFT by providing the request to a server associated with the NFT. Upon receiving the request, the server determines if the user is in a list of authorized users (e.g., determining if one or more parameters are satisfied as described above). Upon determining that the user is not in the list of authorized users, the server provides an indication that it cannot provide the status.

### Example 4: Assigning a Status Upon Minting

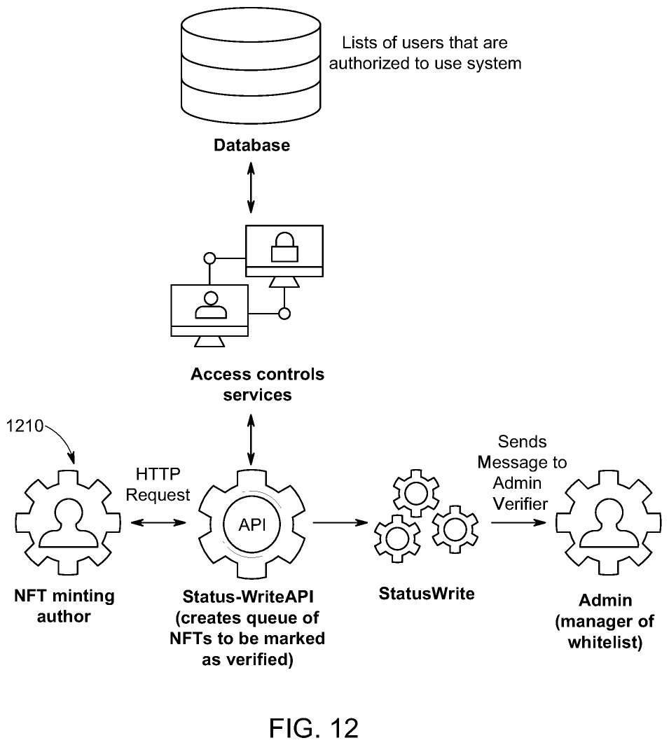

As depicted in FIG. 12, an NFT associated with a user was minted. During process 1210, a request to assign a verified status to the NFT, which was not previously associated with a status, was also provided. An API accessed a database to retrieve a list of authorized users. After retrieving the list of authorized users, it was determined that the user is in the list of authorized users. A verified status was then assigned to the NFT based on the user being in the list of authorized users, and an indication of the verified status was returned to the user.

### Example 5: Example Verified NFT Displayed on a User Interface

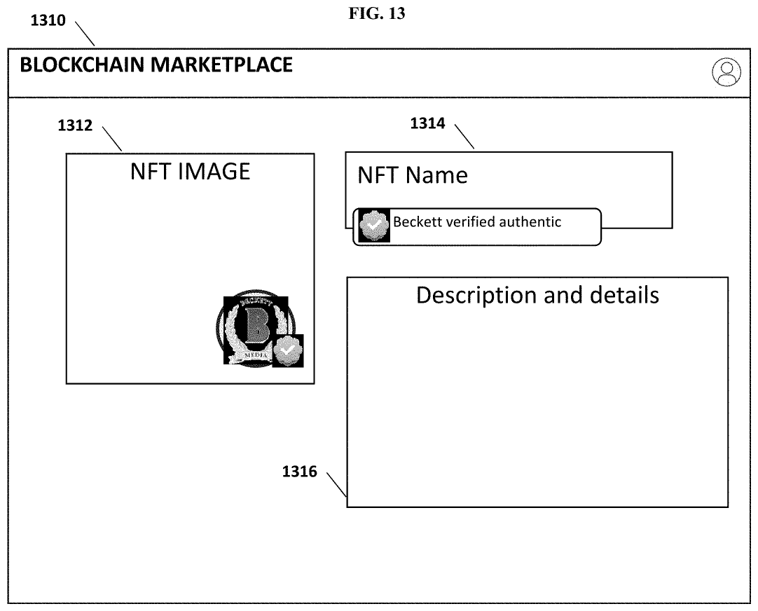

An NFT is assigned a verified status by the methods of FIGS. 2-3 or examples 1-4. The NFT and the verified status of the NFT are provided to the user through a user interface 1310, as depicted in FIG. 13. On the user interface 1310, the NFT is displayed with an indication, such as the B and checkmark in NFT 1312, that indicates the verified status of the NFT. The NFT is also displayed with the verified status itself (e.g., “Beckett verified authentic”), as displayed in informational box 1314. The NFT is also displayed with its name as well as any associated descriptions or details, in descriptor box 1316.

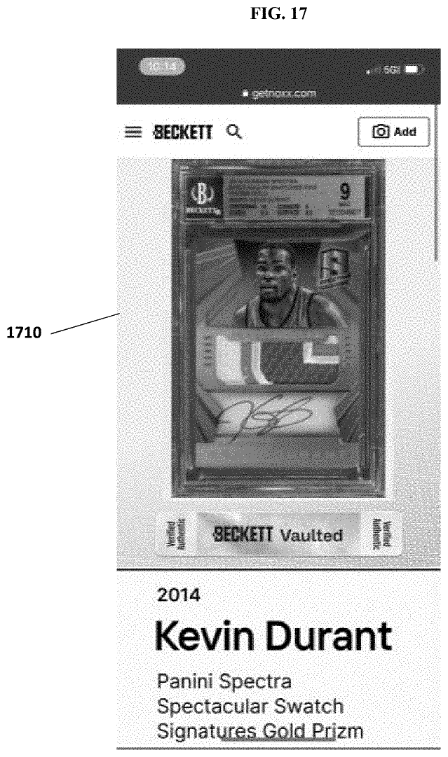

In another example, an NFT is displayed on a user interface as depicted in FIG. 17. On the user interface, the NFT 1710 is displayed with an indication of a verification status (e.g., “Verified Authentic”). The NFT is additionally displayed with an indication that the NFT is vaulted (e.g., “Beckett Vaulted”).

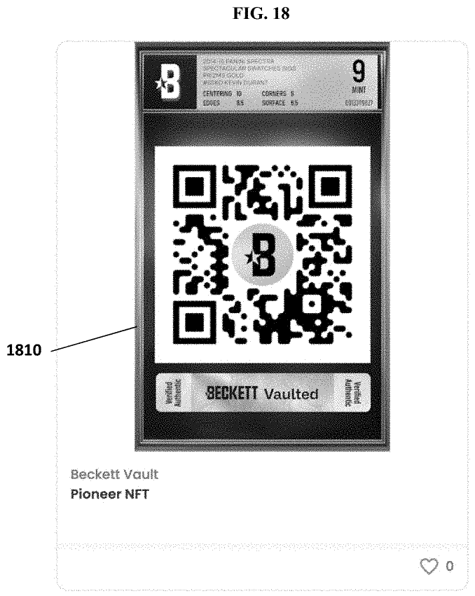

In yet another example, a QR code 1810 that is linked to the NFT is displayed on a user interface as depicted in FIG. 18. The QR code 1810 is displayed with an indication of a verification status (e.g., “Verified Authentic”) and an indication that the NFT is vaulted (e.g., “Beckett Vaulted”). Additionally, when the QR code 1810 is scanned, the NFT may be displayed on a user interface associated with the scanning of the QR code 1810.

### Example 6: Updating a Blockchain when Updating an Aspect of an NFT

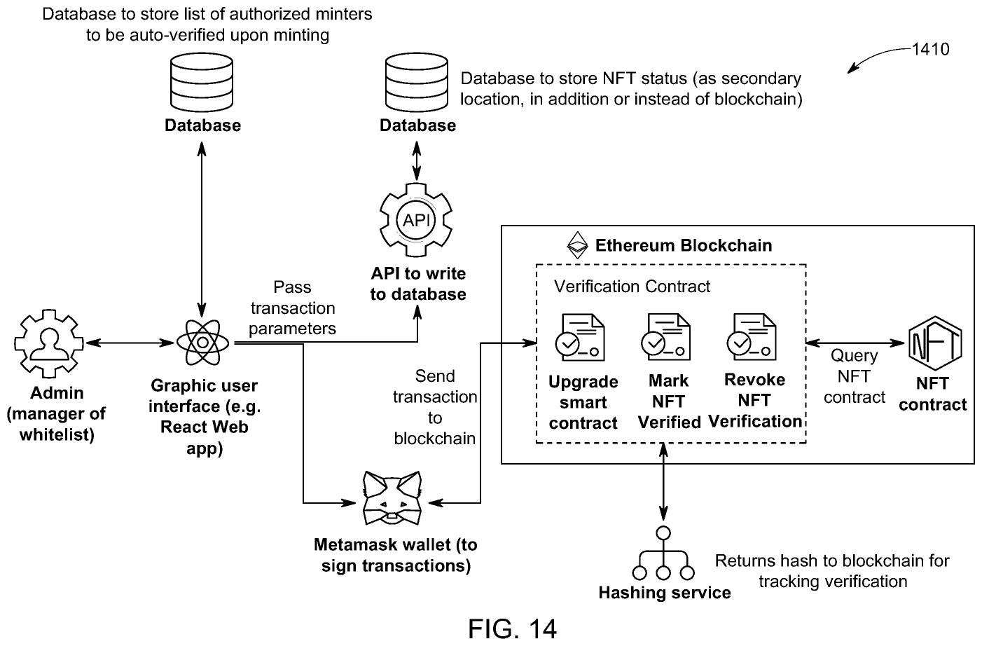

An NFT was assigned a status by the methods of FIG. 2-3 or examples 1-4. During process, 1410, a query was provided to update a status of the NFT based on input to a graphic user interface indicating that the NFT has a verified status, as depicted in FIG. 14. A first database was accessed to determine if the user was associated with an admin role indicating that the user could update aspects of the NFT and to determine if required transaction parameters were satisfied. Upon determining that the user was associated with an admin role and that the transaction parameters were satisfied, a second database including NFTs and aspects of NFTs was accessed to determine a stored status of the NFT. Upon determining the stored aspect, a network is queried to determine a corresponding status of the NFT stored on the network. Upon determining that the stored status and the corresponding status are unverified, a smart contract on the network indicating the unverified status is updated by adding a hash to the smart contract indicating the verified status specified in the query provided to update the status of the NFT, which changed the corresponding aspect to a verified status. The stored status was additionally updated to a verified status based on the query to update the status of the NFT.

In an alternative example of process 1410, only the corresponding status was an unverified status. In said example, the corresponding status was updated based on the hash being added to the smart contract, while the stored status was not changed.

In another alternative example, the stored status was an unverified status while the corresponding status was a verified status. In said example, the stored status was changed to a verified status while the corresponding status was not changed.

In yet another alternative example of process 1410, the stored status and the corresponding status were both verified statuses, while the query provided to update the status of the NFT indicated that the NFT has an unverified status. In said example, the hash added to the smart contract indicates an unverified status, and the stored status and the corresponding status are changed from verified statuses to unverified statuses.

### Example 7: Updating a Smart Contract Based on Request for Verification Status

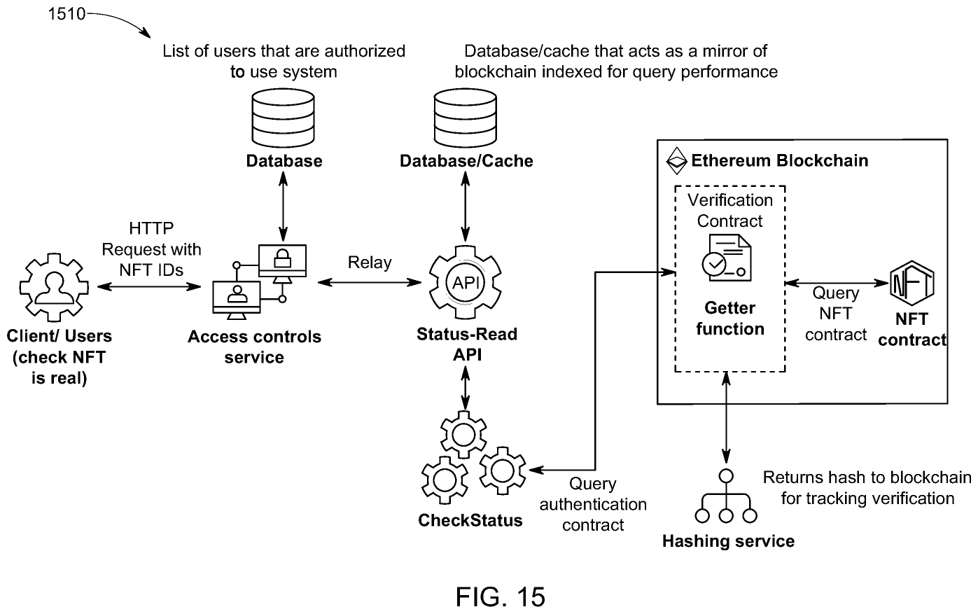

An NFT was assigned a status by the methods of FIG. 2-3 or examples 1-4. During process, 1510, a request for a status verification of the NFT was provided, as depicted in FIG. 15. Based on the request for status verification, a database including an authorized list of users was accessed to determine if the user was authorized to request status verification. Upon determining that the user was authorized, a database containing a stored status was accessed. Upon accessing the stored status, an API was used to query a network including a smart contract associated with the NFT. A function of the smart contract was used to retrieve the status of the NFT stored on the network, and a hash was added to the smart contract indicating the current status. The current status is then returned to the user.

### Example 8: Network Operations after Receiving a Query

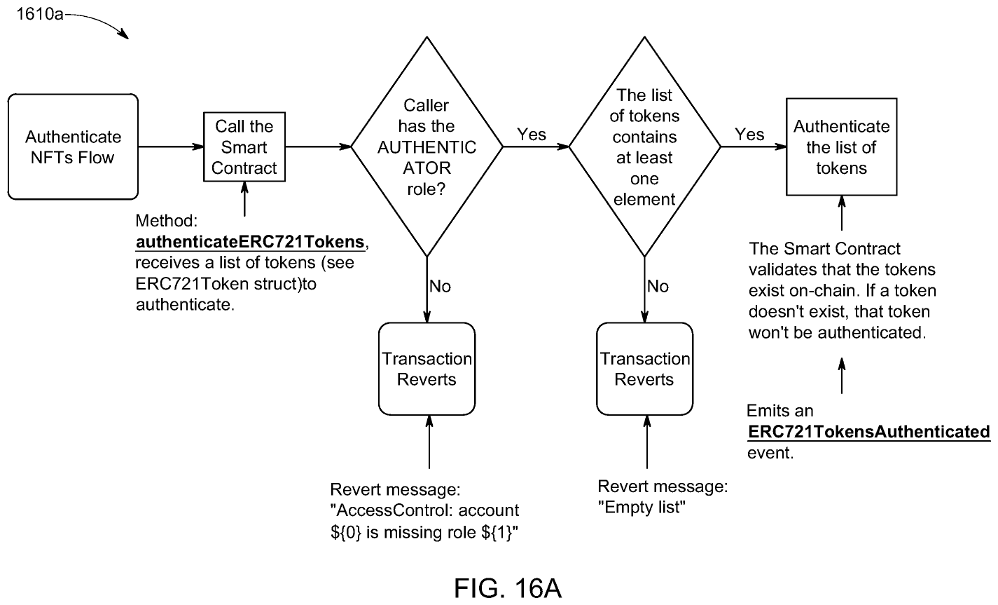

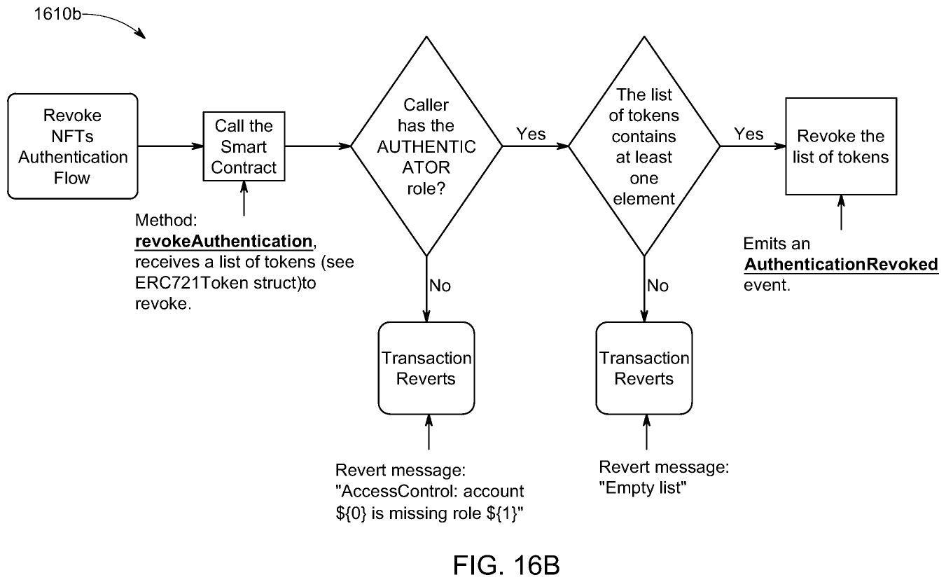

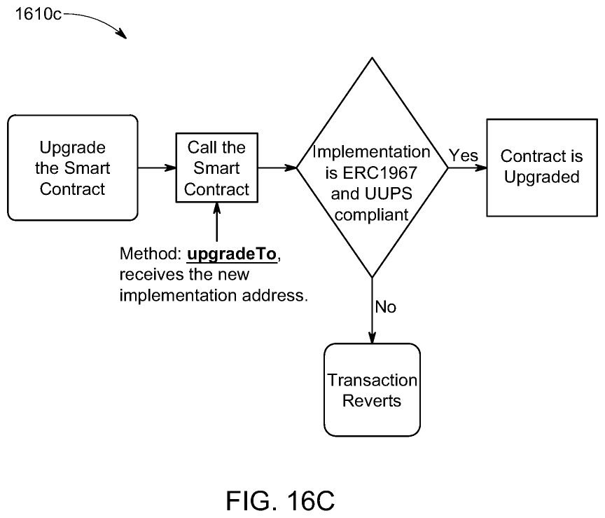

A collection of NFTs (e.g., a “list of tokens”) was assigned a status by the methods of FIGS. 2 and 3 or Examples 1-4. A request to change the status of the collection of NFTs to verified is provided to a network, as depicted in FIGS. 16A-C.

As depicted in FIG. 16A, during process 1610a network calls a smart contract stored on the network. The smart contract executes a function to determine if a user associated with the request is authorized to change the status. Upon determining that the user associated with the request is authorized, the smart contract determines that the collection of NFTs is referenced by the smart contract, and a hash is added to the smart contract indicating that the collection of NFTs is verified.

In an alternative example of process 1610a, the smart contract determines that the user is not authorized to change the status, and thus, does not determine if the collection of NFTs is referenced by the smart contract and a hash is not added to the smart contract.

In another alternative example of process 1610a, the smart contract determines that the collection of NFTs is empty (e.g., the collection of NFTs does not contain any NFTs), and thus, does not verify the status.

As depicted in FIG. 16B, during process 1610b, a request to change the status of the collection of NFTs to unverified is provided to a network. The network calls a smart contract stored on the network. The smart contract executes a function to determine if a user associated with the request is authorized to change the status. Upon determining that the user associated with the request is authorized, the smart contract determines that the collection of NFTs is referenced by the smart contract, and a hash is added to the smart contract indicating that the collection of NFTs is no longer verified.

As depicted in FIG. 16C, during process 1610c, a request to change a different aspect of the collection of NFTs is provided to a network. The network calls a smart contract stored on the network. The smart contract executes a function to determine if a user associated with the request is authorized to change the aspect. Upon determining that the user associated with the request is authorized, the smart contract updates the aspect, and a hash is added to the smart contract indicating the updated aspect.

While preferred embodiments of the present subject matter have been shown and described herein, it will be obvious to those skilled in the art that such embodiments are provided by way of example only. It is not intended that the subject matter described herein be limited by the specific examples provided within the specification. While the present subject matter has been described with reference to the aforementioned specification, the descriptions and illustrations of the embodiments herein are not meant to be construed in a limiting sense. Numerous variations, changes, and substitutions will now occur to those skilled in the art without departing from the subject matter described herein. Furthermore, it shall be understood that all aspects of the present subject matter are not limited to the specific depictions, configurations or relative proportions set forth herein which depend upon a variety of conditions and variables. It should be understood that various alternatives to the embodiments of the subject matter described herein may be employed in practice. It is therefore contemplated that the present subject matter shall also cover any such alternatives, modifications, variations or equivalents. It is intended that the following claims define the scope of the present subject matter and that methods and structures within the scope of these claims and their equivalents be covered thereby.

What is claimed is:

1. A method for verifying an electronic article, comprising:
receiving a request for a status verification of an electronic article;
retrieving one or more aspects associated with the electronic article from a database comprising a plurality of aspects associated with a plurality of electronic articles;
providing the one or more aspects to a network comprising a blockchain;
receiving, from the network, one or more corresponding aspects based on the provided one or more aspects;
determining the status verification, wherein the status verification comprises a verified status or an unverified status; and
providing the status verification in response to the request.

2. The method of claim 1, wherein providing the one or more aspects to the network comprises querying a smart contract to compare the one or more aspects to the one or more corresponding aspects.

3. The method of claim 1, further comprising:
receiving a hash associated with the electronic article; and
providing the hash to the smart contract.

4. The method of claim 1, further comprising:
generating a hash based on the status verification; and
providing the hash to a smart contract on the network.

5. The method of claim 4, wherein the smart contract is updated to include the hash.

6. The method of claim 1, further comprising updating a first status associated with the electronic article from unverified to verified based on the status verification.

7. The method of claim 1, further comprising updating a first status associated with the electronic article from verified to unverified based on the status verification.

8. The method of claim 1, wherein the electronic article is a non-fungible token.

9. The method of claim 1, wherein the electronic article is associated with an analog, wherein the analog comprises at least one of:
a photograph;
a collectible item;
a sports card;
a comic book;
a coin;
an action figure;
a pair of shoes;
an autograph;
a military vintage item;
a car part;
a videotape;
a stamp;
a painting;
a drawing;
music;
a building; or
a sculpture.

10. The method of claim 1, wherein the one or more aspects comprises at least one of:
an ownership of the analog;
an ownership of the electronic article;
an unverified status of the electronic article;
a verified status of the electronic article;
a type of the analog;
a rating of the electronic article; or
a first address of the electronic article.

11. A system, comprising:
one or more processors; and
a memory comprising executable instructions which, when executed by the one or more processors, cause the system to:
receive a request for a status verification of an electronic article;
retrieve one or more aspects associated with the electronic article from a database comprising a plurality of electronic articles comprising the electronic article;
provide the one or more aspects to a smart contract;
receive, from the smart contract, one or more corresponding aspects based on the provided one or more aspects;
determine the status verification, wherein the status verification comprises a verified status or an unverified status; and
provide the status verification in response to the request.

12. The system of claim 11, wherein the one or more processors being configured to cause the system to provide the one or more aspects to the smart contract comprises the one or more processors being configured to cause the system to query the smart contract to compare the one or more aspects to the one or more corresponding aspects.

13. The system of claim 11, wherein one or more processors are further configured to cause the system to:
generate a hash associated with the electronic article; and
provide the hash to the smart contract.

14. The system of claim 11, wherein the electronic article is associated with an analog, wherein the analog comprises at least one of:
a photograph;
a collectible item;
a sports card;
a comic book;
a coin;
an action figure;
a pair of shoes;
an autograph;
a military vintage item;
a car part;
a videotape;
a stamp;
a painting;
a drawing;
music;
a building; or
a sculpture.

15. The system of claim 11, wherein the one or more aspects comprises at least one of:
an ownership of the analog;
an ownership of the electronic article;
an unverified status of the electronic article;
a verified status of the electronic article;
a type of the analog;
a rating of the electronic article; or
a first address of the electronic article.

16. A non-transitory, computer-readable medium comprising executable instructions, wherein when a processor, when executing the executable instructions, performs a method for verifying an electronic article, the method comprising:
receiving a request for a status verification of an electronic article;
retrieving one or more aspects associated with the electronic article from a database comprising a plurality of electronic articles comprising the electronic article;
providing the one or more aspects to a smart contract;
receiving, from the smart contract, one or more corresponding aspects based on the provided one or more aspects;
determining the status verification, wherein the status verification comprises a verified status or an unverified status; and
providing the status verification in response to the request.

17. The computer-readable medium of claim 16, wherein providing the one or more aspects to the network comprises querying a smart contract to compare the one or more aspects to the one or more corresponding aspects.

18. The computer-readable medium of claim 16, further comprising:
generating a hash based on the status verification; and
providing the hash to the smart contract.

19. The computer-readable medium of claim 16, the method further comprising updating a first status associated with the electronic article from unverified to verified based on the status verification.

20. The computer-readable medium of claim 16, wherein the one or more aspects comprises at least one of:
an ownership of the analog;
an ownership of the electronic article;
an unverified status of the electronic article;
a verified status of the electronic article;
a type of the analog;
a rating of the electronic article; or
a first address of the electronic article.
